(19) United States
(12) Patent Application Publication
(10) Pub. No.: US 2021/0025738 A1
(43) Pub. Date: Jan. 28, 2021

(54) SYSTEM AND METHOD FOR DEVICE OPERATION MONITORING

(71) Applicant: EMC IP Holding Company LLC, Hopkinton, MA (US)

(72) Inventors: Alon Weinberg, Haifa (IL); Assaf Natanzon, Tel Aviv (IL)

(21) Appl. No.: 16/521,586

(22) Filed: Jul. 24, 2019

(51) Int. Cl. G01D 18/00

(52) U.S. Cl. CPC G01D 18/00

(57) ABSTRACT

A sensing device monitor for monitoring operation of sensing devices includes persistent storage for storing a scene signature associated with a sensing device of the sensing devices and a sensing device manager. The sensing device manager generates a challenge based, at least in part, on the scene signature; issues the challenge to, at least, the sensing device to obtain a challenge response; makes a determination that the challenge response does not pass the challenge; and in response to the determination: remediates the sensing device.

### BACKGROUND

Devices may generate information based on existing information. For example, devices may obtain information and derive information based on the obtained information. To obtain information, devices may be able to communicate with other devices. The communications between the devices may be through any means.

### SUMMARY

In one aspect, a sensing device monitor for monitoring operation of sensing devices in accordance with one or more embodiments of the invention includes persistent storage for storing a scene signature associated with a sensing device of the sensing devices and a sensing device manager. The sensing device manager generates a challenge based, at least in part, on the scene signature; issues the challenge to, at least, the sensing device to obtain a challenge response; makes a determination that the challenge response does not pass the challenge; and in response to the determination: remediates the sensing device.

In one aspect, a method for monitoring operation of sensing devices in accordance with one or more embodiments of the invention includes generating a challenge based, at least in part, on a scene signature associated with a sensing device of the sensing devices; issuing the challenge to, at least, the sensing device to obtain a challenge response; making a determination that the challenge response does not pass the challenge; and in response to the determination: remediating the sensing device.

In one aspect, a non-transitory computer readable medium in accordance with one or more embodiments of the invention includes computer readable program code, which when executed by a computer processor enables the computer processor to perform a method for monitoring operation of sensing devices. The method includes generating a challenge based, at least in part, on a scene signature associated with a sensing device of the sensing devices; issuing the challenge to, at least, the sensing device to obtain a challenge response; making a determination that the challenge response does not pass the challenge; and in response to the determination: remediating the sensing device.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of an example sensing device in accordance with one or more embodiments of the invention.

FIG. 1.3 shows a first diagram of a region of space in accordance with one or more embodiments of the invention.

FIG. 1.4 shows a second diagram of the region of space of FIG. 1.3 in accordance with one or more embodiments of the invention.

FIG. 1.5 shows a diagram of an example sensing device monitor in accordance with one or more embodiments of the invention.

FIG. 2 shows a diagram of an example scene signature in accordance with one or more embodiments of the invention.

FIG. 3.1 shows a flowchart of a method of monitoring a scene in accordance with one or more embodiments of the invention.

FIG. 3.2 shows a flowchart of a method of monitoring sensing devices in accordance with one or more embodiments of the invention.

FIG. 3.3 shows a continuation of the flowchart of FIG. 3.2.

FIG. 4.1 shows a diagram of an example system, similar to the system of FIG. 1.1, at a first point in time.

FIG. 4.2 shows a diagram of the example system of FIG. 4.1 at a second point in time.

FIG. 4.3 shows a diagram of the example system of FIG. 4.1 at a third point in time.

FIG. 4.4 shows a diagram of the example system of FIG. 4.1 at a fourth point in time.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing the operational states of sensing devices. A sensing device may be a device that monitors the state (e.g., objects disposed in a scene) of a scene. The monitoring may be performed by obtaining sensor data from sensors that are adapted to obtain information regarding the scene.

A system in accordance with one or more embodiments of the invention may include a sensing device monitor. The sensing device monitor may monitor the operational states of the sensing devices. The monitoring of the operational states of the sensing devices may be used to determine whether it is likely that the monitoring of the scenes by the sensing devices results in information regarding the scenes that accurately reflects the states of the scenes. For example, a damaged sensing device may provide inaccurate information regarding a monitored scene.

To monitor the sensing devices, the sensing device monitor may, while the sensing devices are in a predetermined state, obtain a scene signature of a scene monitored by a sensing device. The scene signature may be used to determine, at future points in time, whether the sensing device is in a predetermined operating state that results in the generation of accurate information regarding a monitored scene. If the sensing device is not in the predetermined state, the sensing device monitor may take action to remediate the sensing device. Remediating the sensing device may result in the sensing device being placed in the predetermined state which improves the likelihood that monitoring of the scene by the sensing device results in the generation of accurate information regarding the scene.

By monitoring the operational states of the sensing devices, operations of the sensing devices may be validated (e.g., determined as providing accurate or inaccurate information regarding a scene). In one or more embodiments of the invention, the sensing devices may be validated while the sensing devices are performing real time operations such as, for example, providing surveillance services with respect to scenes.

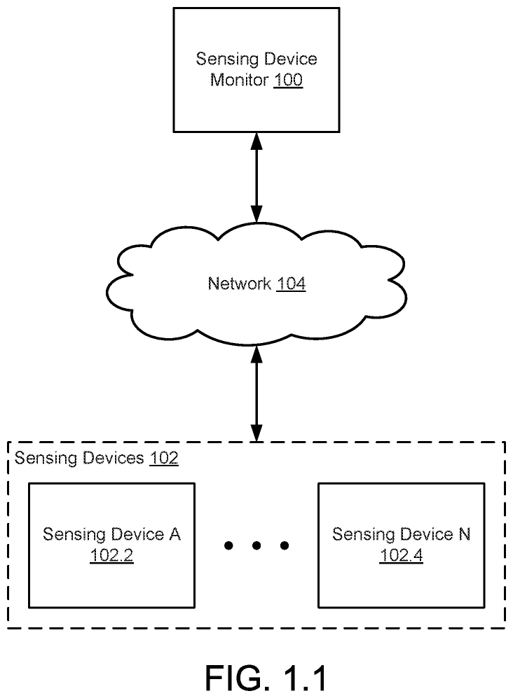

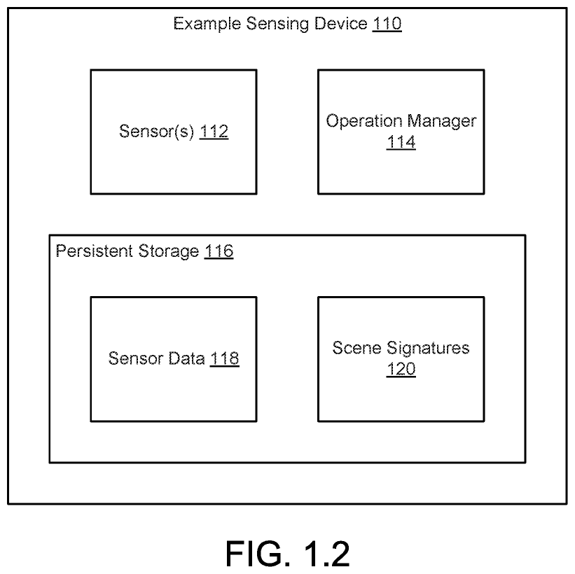

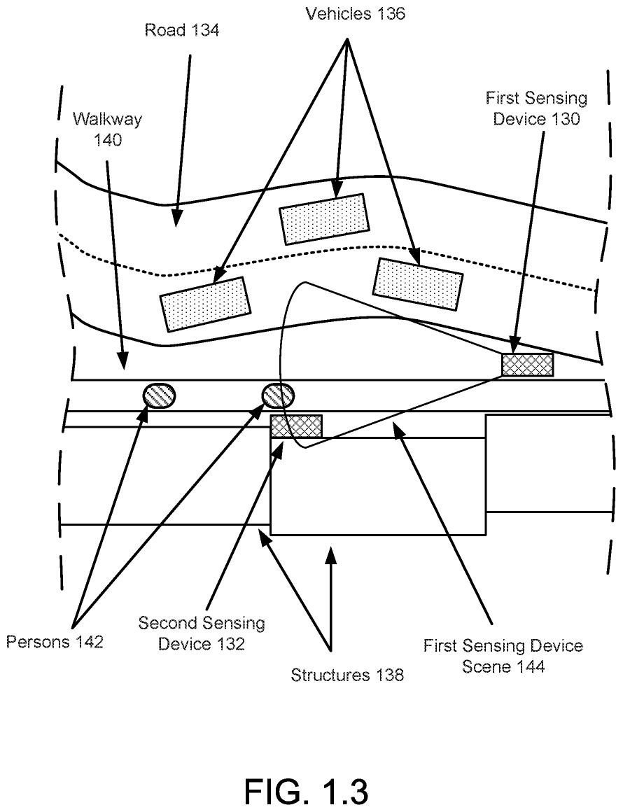

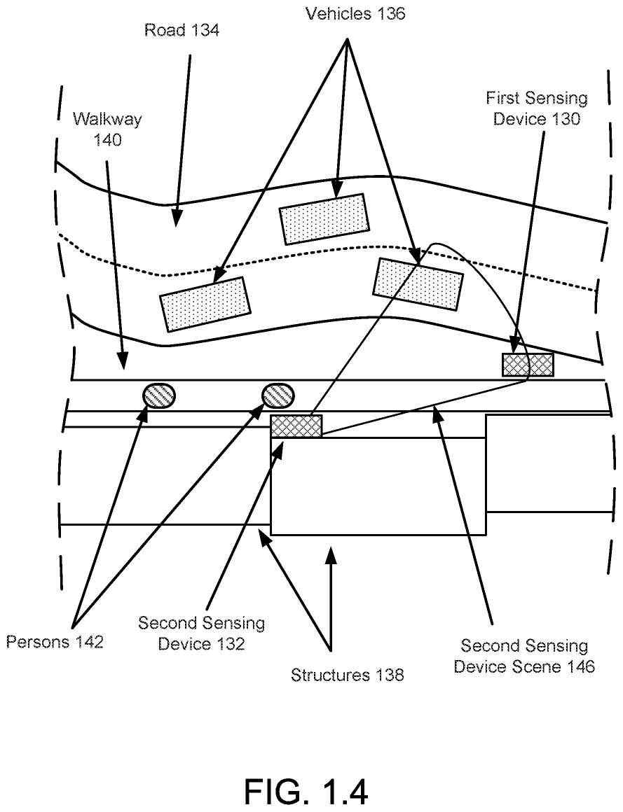

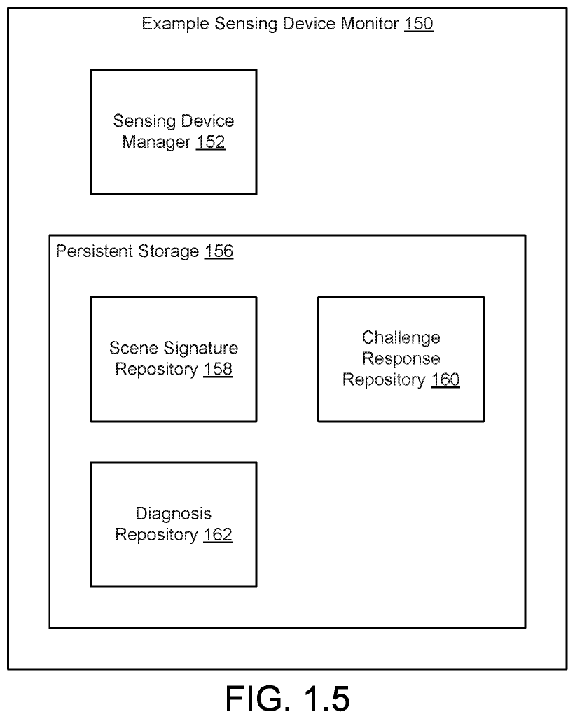

FIG. 1.1 shows a system in accordance with one or more embodiments of the invention. The system may include any number of sensing devices (102) operably connected to a sensing device monitor (100). The sensing device (102) may be operably connected to the sensing device monitor (100) by a network (104).

The network (104) may facilitate communications between the aforementioned devices. The network may utilize any number of operable connections supported by any number and/or combination of wired and/or wireless networks to facilitate communications between the aforementioned devices.

The network (104) may facilitate communications by enabling network data units to be transferred between the aforementioned devices. The network data units may correspond to any (combination of) type(s) of basic data unit (e.g., a packet) supported by any type of communication protocol. Different portions of the network (104) may facilitate communications using the same and/or different types of network data units. The network data units may include any type and/quantity of information.

Each of the sensing devices (e.g., 102.2, 102.4) may be adapted to provide monitor services. The monitoring services may be provided for respective scenes (e.g., a physical region of space) associated with respective sensing devices (102). The monitoring services may enable information regarding the respective scene to be obtained.

The monitoring services may be used, for example, to determine whether an action with respect to a scene or another scene should be taken. The action may be, for example, to send an alert to an entity, to direct resources to a scene, to determine that an object of interest is disposed in the scene, and/or to perform any other type of action that may be based on information regarding the scene.

The sensing device monitor (100) may be adapted to provide monitoring services for one or more of the sensing devices (102). The monitoring services provided by the sensing device monitor (100) may enable the operational states of the one or more sensing devices (102) to be determined. The operational state of the one or more sensing devices (102) may correspond to the ability of the one or more sensing devices (102) to perform predetermined functionality. The predetermined functionality may be, for example, to obtain information regarding a scene associated with a sensing device.

By providing monitoring services, the sensing device monitor (100) may be able to determine whether a sensing device is malfunctioning. For example, if the sensing device monitor (100) determines that an operational state of the sensing device is not associated with the ability of the sensing device to perform the predetermined functionality, the sensing device monitor (100) may determine that the sensing device is malfunctioning. If a sensing device is determined to be malfunctioning, the sensing device monitor (100) may perform an action set to remediate the sensing device.

To further clarify embodiments of the invention, components of the system of FIG. 1.1 are discussed below.

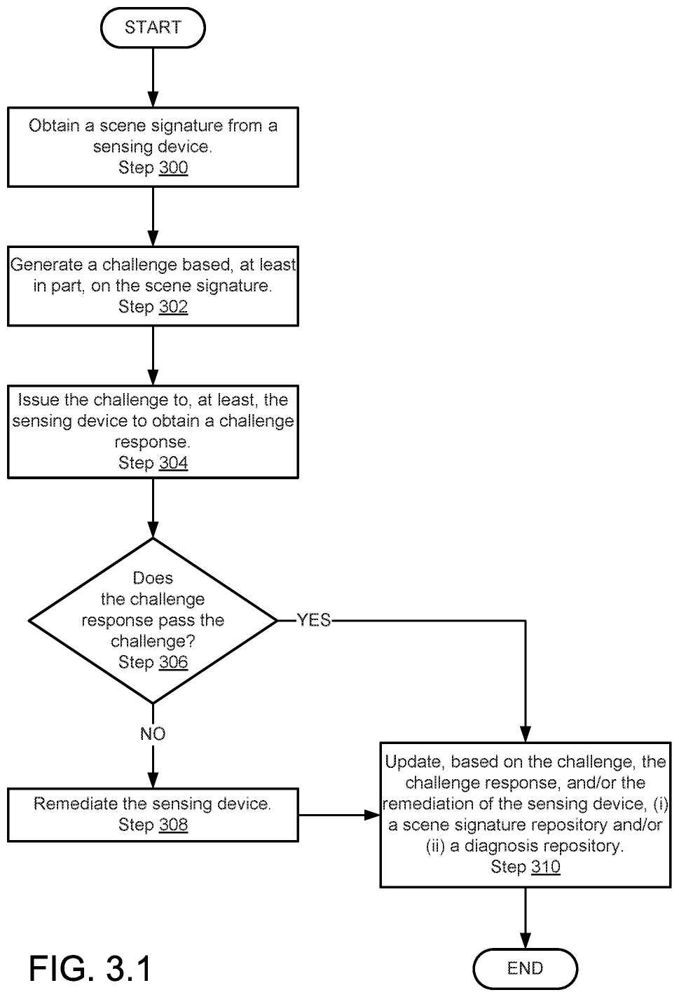

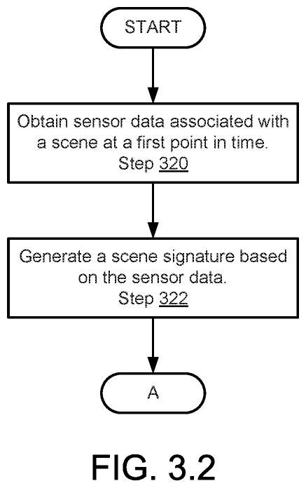

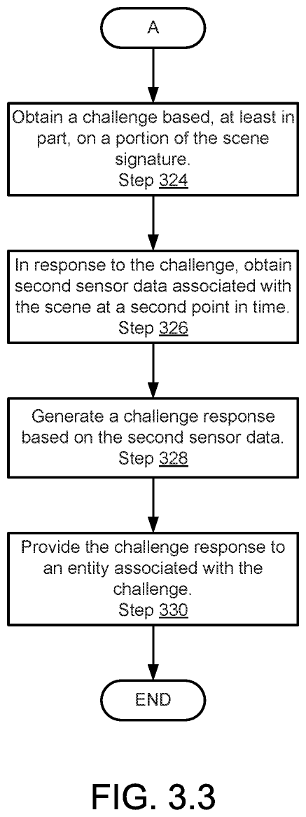

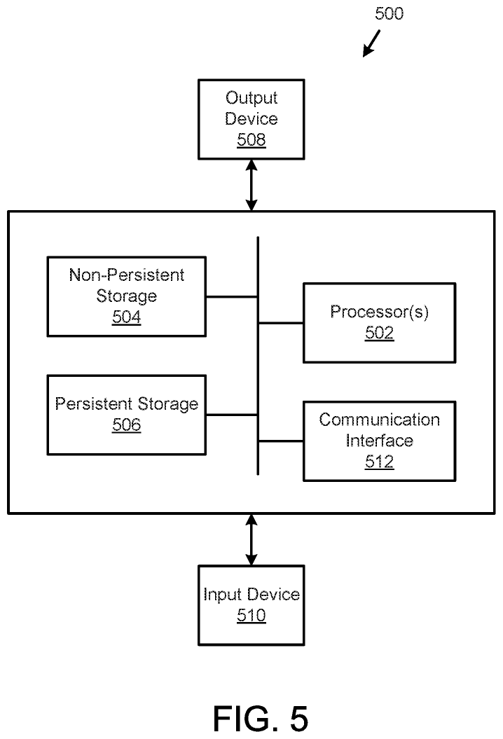

The sensing devices (102) may be implemented as computing devices. The computing devices may be, for example, embedded computing devices, mobile phones, tablet computers, laptop computers, desktop computers, servers, network devices, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 3.1-3.3. The sensing devices (102) may be other types of computing devices without departing from the invention. For additional details regarding computing devices, refer to FIG. 5.

The sensing devices (102) may be logical devices without departing from the invention. For example, the sensing devices (102) may be implemented as virtual machines or other types of logical entities that utilize computing resources of any number of physical computing devices to provide the functionality of the sensing devices (102). The sensing devices (102) may be other types of logical devices without departing from the invention.

In one or more embodiments of the invention, the sensing devices (102) provide scene monitoring services. Providing scene monitoring services may include (i) facilitating generation of one or more scene signatures for a scene associated with a sensing device, (ii) monitoring of the scene, and (iii) facilitating determination of operating states of the sensing devices (102).

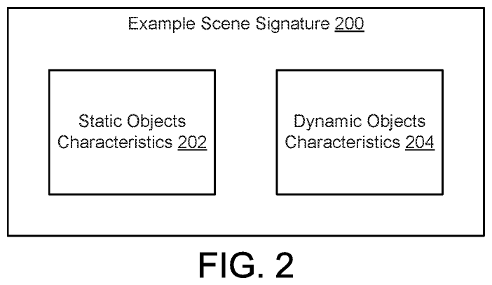

To facilitate generation of one or more scene signatures, the sensing devices (102) may obtain sensor data regarding a scene. The one or more scene signatures may be based on the sensor data. The sensor data may be any quantity and types of measurements of a scene over any period(s) of time and/or at any point(s) in time. The sensor data may be obtained using one or more sensors. The sensor may be, for example, visual sensors (e.g., cameras), audio sensors (e.g., microphones), and/or any other types of sensors (e.g., electromagnetic radiation sensors such as infrared sensors, transceivers, etc.; chemical detection sensors; etc.). The scene signature(s) may be one or more data structures that include information regarding static and/or dynamic objects included in the scene prior to, during, and/or after the sensor data was obtained. For additional details regarding scene signatures, refer to FIG. 2.

To monitor the scene, the sensing devices (102) may obtain sensor data regarding a scene, as discussed above with respect to generation of one or more scene signatures. To monitor the scene, the sensing devices (102) may provide to other entities, store, or otherwise utilize (i) the sensor data and/or (ii) information regarding a scene based on the sensor data.

To facilitate determination of the operating states of the sensing devices (102), the sensing devices (102) may obtain challenges from other entities (e.g., a sensing device monitor). The challenge may be a data structure that includes information regarding one or more actions to be performed by the sensing device that obtained the challenge. The sensing devices (102) may perform the one or more actions in response to obtaining the challenge. Performing the challenge may caused the sensing devices (102) to obtain information regarding a scene and/or provide to another entity, store, or otherwise utilize the obtained information regarding the scene. By doing so, the other entities (and/or the sensing devices) may obtain information regarding a scene from which the other entities may diagnose an operating state of the sensing devices.

In one or more embodiments of the invention, all, or a portion, of the sensing devices (102) are implemented as connected edge devices. The connected edge devices may provide surveillance services for scenes. Surveillance services may include determining object-level information (e.g., information regarding objects in a scene) regarding a scene. The object-level information may be provided to other entities.

To provide the above noted functionality of the sensing devices (102), the sensing devices may perform all, or a portion, of the methods illustrated in FIGS. 3.1-3.3. For additional details regarding sensing devices, refer to FIG. 1.2.

The sensing device monitor (100) may be implemented as a computing device.

The computing devices may be, for example, an embedded computing device, mobile phone, tablet computer, laptop computer, desktop computer, server, network device, or cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 3.1-3.3. The sensing device monitor (100) may be other types of computing devices without departing from the invention. For additional details regarding computing devices, refer to FIG. 5.

The sensing device monitor (100) may be a logical device without departing from the invention. For example, the sensing device monitor (100) may be implemented as a virtual machine or another type of logical entity that utilizes computing resources of any number of physical computing devices to provide the functionality of the sensing device monitor (100). The sensing device monitor (100) may be another type of logical device without departing from the invention.

In one or more embodiments of the invention, the sensing device monitor (100) provides sensing device monitoring services. Providing sensing device monitoring services may include (i) obtaining one or more scene signatures of scenes associated with the sensing devices (102) and (ii) monitoring the operational states of the sensing devices (102) using the one or more scene signatures.

To obtain the one or more scene signatures of scenes associated with the sensing devices (102), the sensing device monitor (100) may send requests for scene signatures to the sensing devices. In response to the requests, the sensing devices may generate the scene signatures and provide the one or more scene signatures to the sensing device monitor.

To monitor the operational states of the sensing devices (102), the sensing device monitor (100) may generate challenges based on the one or more scene signatures, facilitate performance of all, or a portion, of the one or more challenges by one or more of the sensing devices (102) to obtain challenge responses from the sensing devices, and determine the operational states of the sensing devices (102) based on the challenge responses. The challenges may be data structures that indicate one or more actions to be performed by a sensing device. The one or more actions may cause a sensing device to obtain information regarding a scene, generate a challenge response based on the information regarding the scene, and/or provide the challenge response to the sensing device monitor (100) and/or one or more other entities.

To provide the above noted functionality of the sensing device monitor (100), the sensing devices may perform all, or a portion, of the methods illustrated in FIGS. 3.1-3.3. For additional details regarding sensing device monitors, refer to FIG. 1.5.

While the system of FIG. 1.1 has been illustrated and described as including a limited number of specific components (e.g., the sensing device monitor (100), the sensing devices (102)), a system in accordance with one or more embodiments of the invention may include additional, fewer, and/or different components without departing from the invention. For example, a system in accordance with one or more embodiments of the invention may include multiple sensing device monitors that each provide sensing device monitoring services to corresponding portions of the sensing devices (102). In another example, a system in accordance with one or more embodiments of the invention may include remote storage for storing data (e.g., scene signatures, challenges, challenge responses, etc.). In a still further example, a system in accordance with one or more embodiments of the invention may include a management entity that manages (e.g., coordinates) the operation of multiple sensing device monitors and/or the sensing devices and/or other devices not illustrated in FIG. 1.1.

To further clarify aspects of embodiments of the invention, a diagram of an example sensing device (110) in accordance with one or more embodiments of the invention is shown in FIG. 1.2. FIG. 1.2 may be a functional block diagram of the example sensing device (110). The sensing devices (102, FIG. 1.1) of FIG. 1.1 may be similar to the example sensing device (110).

As discussed above, sensing devices may provide scene monitoring services. To provide scene monitoring services, the example sensing device (110) may include and/or be operatively coupled to one or more sensors (112), an operation manager (114), and/or persistent storage (116). Each of these components of the example sensing device (110) is discussed below.

The one or more sensors (112) may be one or more physical devices adapted to obtain information regarding one or more scenes. A scene may be a region of space. For example, a scene may be a region of space in which all, or a portion, of the one or more sensors (112) may obtain information regarding the region of space. For additional details regarding scenes, refer to FIGS. 1.3-1.4.

The one or more sensors (112) may be any type and/or combination of types of physical devices adapted to obtain information regarding the one or more scenes. For example, the one or more sensors (112) may include a camera adapted to obtain optical information (e.g., a pattern of light scattered off of the scene) regarding a scene. In another example, the one or more sensors (112) may include a microphone adapted to obtain auditory information (e.g., a pattern of sound from the scene) regarding a scene. In one or more embodiments of the invention, the one or more sensors (112) only include a single sensor. In one or more embodiments of the invention, the one or more sensors (112) includes multiple sensors.

Different sensing devices may include different numbers and/or types of sensors without departing from the invention. For example, a first sensing device may only include a camera adapted to obtain information regarding optical radiation while a second sensing device may include a microphone and an infrared camera adapted to obtain information regarding infrared radiation.

The operation manager (114) may be adapted to orchestrate operation of the example sensing device (110). For example, the operation manager (114) may include functionality to obtain data (e.g., sensor data) that includes information regarding a scene that was obtained by the one or more sensors (112), store/retrieve data (e.g., sensor data (118), scene signatures (120)) in the persistent storage (116), and/or provide scene monitoring services as discussed above. To provide the above noted functionality of the operation manager (114), the operation manager (114) may perform all, or a portion, of the methods illustrated in FIGS. 3.1-3.3.

In one or more embodiments of the invention, the operation manager (114) is implemented using a hardware device that includes circuitry. The circuitry of the hardware device may be adapted to perform all, or a portion, of the functionality of the operation manager (114) and/or all, or a portion, the methods illustrated in FIGS. 3.1-3.3. The hardware device may be, for example, a digital signal processor, a field programmable gate array, or an application specific integrated circuit. The hardware device may be other types of hardware devices without departing from the invention.

In one or more embodiments of the invention, the operation manager (114) is implemented using computing code stored on a persistent storage that when executed by a processor performs all, or a portion, of the functionality of the operation manager (114) and/or all, or a portion, of the methods illustrated in FIGS. 3.1-3.3. The processor may be a hardware processor including circuitry such as, for example, a central processing unit or a microcontroller. The processor may be other types of hardware devices for processing digital information without departing from the invention.

In one or more embodiments of the invention, the persistent storage (116) provides data storage services to the one or more sensors (112), the operation manager (114), and/or other entities. The data storage services may include storing of data and providing of previous stored data. The persistent storage (116) may be implemented using any combination of physical storage device(s), logical storage device(s), and/or other types of devices (e.g., storage device controllers, load balances, encoders, etc.) for facilitating provisioning of data storage services.

A logical storage device may be an entity that utilizes the physical storage devices of one or more computing devices to provide data storage services. For example, a logical storage may be a virtualized storage that utilizes any quantity of storage resources (e.g., physical storage devices) of any number of computing devices.

A physical storage device may be a physical device that provides data storage services. For example, a physical storage device may include any number of physical devices such as, for example, hard disk drives, solid state drives, tape drives, and/or other types of hardware devices that store data. The physical storage device may include any number of other types of hardware devices for providing data storage services. For example, the physical storage device may include storage controllers that balance and/or allocate storage resources of hardware devices, load balancers that distribute storage workloads across any number of hardware devices, memory for providing cache services for the hardware devices, etc.

The persistent storage (116) may store data structures including the sensor data (118) and scene signatures (120). Each of these data structures is discussed below.

The sensor data (118) may be a data structure that includes any quantity and type of information obtained from the one or more sensors (112). Different portions of the sensor data (118) may be associated with different periods of time and/or points in time. The periods of time and/or points in time may be associated when the corresponding portions of the sensor data (118) were obtained.

The sensor data (118) may also include information (e.g., metadata) regarding each portion of sensor data of the sensor data (118). The metadata may include, for example, information that associates each portion of sensor data of the sensor data (118) with one or more points in time and/or one or more periods of time. The metadata of the sensor data (118) may include additional, less, and/or different types of information without departing from the invention.

The sensor data (118) may be implemented as, for example, a list. Each entry of the list may include information representative of, for example, (i) periods of time and/or points in time associated with when a portion of sensor data included in the entry was obtained and/or (ii) the portion of sensor data. The sensor data (118) may have different organizational structures without departing from the invention. For example, the sensor data (118) may be implemented as a tree, a table, a linked list, etc.

The scene signatures (120) may be a data structure that includes one or more scene signatures. As discussed above, a scene signature may be a data structure based on sensor data. The scene signature may include information regarding one or more objects disposed in a scene at one or more points in time and/or over one or more periods of time. The scene signatures (120) may include any number of scene signatures without departing from the invention.

The scene signatures (120) may also include information (e.g., metadata) regarding each scene signature of the scene signatures. The metadata may include, for example, information that associates each respective scene signature of the scene signatures (120) with one or more points in time and/or one or more periods of time. The metadata of the scene signatures (120) may include additional, less, and/or different types of information without departing from the invention.

The scene signatures (120) may be implemented as, for example, a list. Each entry of the list may include information representative of, for example, (i) periods of time and/or points in time associated with a scene signature included in the entry and/or (ii) the scene signature. The scene signatures (120) may have different organizational structures without departing from the invention. For example, the scene signatures (120) may be implemented as a tree, a table, a linked list, etc. For additional details regarding scene signatures (120), refer to FIG. 2.

While the data structures (e.g., 118, 120) are illustrated as separate data structures and have been discussed as including a limited amount of specific information, any of the aforementioned data structures may be divided into any number of data structures, combined with any number of other data structures, and/or may include additional, less, and/or different information without departing from the invention. Additionally, while illustrated as being stored in the persistent storage (116), any of the aforementioned data structures may be stored in different locations (e.g., in persistent storage of other computing devices) and/or spanned across any number of computing devices without departing from the invention.

While the example sensing device (110) of FIG. 1.2 has been described and illustrated as including a limited number of components for the sake of brevity, a sensing device in accordance with embodiments of the invention may include additional, fewer, and/or different components than those illustrated in FIG. 1.2 without departing from the invention.

As discussed above, sensing devices may provide scene monitoring services. To do so, the sensing devices may obtain information regarding a scene. To further clarify aspects of embodiments of the invention, top view diagrams of regions of space that include scenes (e.g., 144, 146) in accordance with one or more embodiments of the invention are illustrated in FIGS. 1.3-1.4.

FIG. 1.3 shows a top view diagram (e.g., a birds eye view) of a region of space in accordance with one or more embodiments of the invention. The region of space includes structures (138) adjacent to a road (134). Vehicles (136) are traveling on the road (134). The structures (138) are separated from the road (134) by a walkway (140). Persons (142) are traveling on the walkway (140).

To monitor (e.g., determine information regarding the vehicles (136), the persons (142), and/or other objects) portions of the region of space, a first sensing device (130) may be disposed between the walkway (140) and the road (134) while a second sensing device (132) may be disposed between the structures (138) and the walkway (140). In FIG. 1.3, the first sensing device (130) may provide scene monitoring services for the first sensing device scene (144). The first sensing device (130) may provide scene monitoring services for the portion of the region of space delineated by the boundary of the first sensing device scene (144).

As seen from FIG. 1.3, the first sensing device scene (144) may include a portion of the road (134), a portion of the walkway (140), and a portion of the second sensing device (132). Consequently, sensor data obtained by the first sensing device (130) may correspond to a portion of the vehicles (136), the persons (142), and the second sensing device (132).

For example, the first sensing device (130) may include a camera that provides sensor data in the form of images of the objects in the first sensing device scene (144). The sensor data may be used to, for example, deduce a rate of vehicles that pass by the first sensing device (130), a number of persons on the walkway (140) at a point in time, characteristics (e.g., position/orientation, state of optical indicates such as lights, etc.) of the second sensing device (132), etc.

FIG. 1.4 shows a second diagram of the region of space in FIG. 1.3 in accordance with one or more embodiments of the invention. In FIG. 1.4, a second sensing device scene (146) is illustrated while the first sensing device scene (144) has been removed for simplicity.

As seen from FIG. 1.4, the second sensing device scene (146) may include a portion of the road (134), a portion of the walkway (140), and a portion of the first sensing device (130). Consequently, second sensor data obtained by the second sensing device (132) may correspond to a portion of the vehicles (136), the persons (142), and the first sensing device (130).

For example, the second sensing device (132) may include an infrared camera that provides sensor data in the form of infrared images of the objects in the first sensing device scene (144). The second sensor data may be used to, for example, deduce a rate of vehicles that pass by the second sensing device (132), a number of persons on the walkway (140) at a point in time, characteristics (e.g., position/orientation, state of optical indicates such as lights, etc.) of the first sensing device (130), etc.

While the region of space shown in FIGS. 1.3-1.4 has been illustrated as including a limited number and specific types of components, regions of space in accordance with embodiments of the invention may include additional, fewer, and/or different components without departing from the invention. For example, additional sensing devices may be included in the region of space without departing from the invention.

Additionally, while the first sensing device scene (144) and the second sensing device scene (146) have been illustrated as having a specific shape, sensing devices in accordance with one or more embodiments of the invention may monitor scenes having different shapes. Further, the scenes monitored by different sensing devices may have different or the same shape without departing from the invention.

While the first sensing device scene (144) and the second sensing device scene (146) have been illustrated as two-dimensional shapes, one of ordinary skill in the art will appreciate that scenes monitored by sensing devices in accordance with one or more embodiments of the invention may be three dimension (e.g., a cone, sphere, cylinder, or a more complex shape/aggregation of shapes) in nature. Further, different sensors of a sensing device may monitor similar and/or different scenes. For example, a first camera and a second camera of a sensing device may monitor the same scene from different perspectives. In another example, a first camera and a second camera of a sensing device may monitor different scenes.

Due to the nature of environments such as those illustrated in FIGS. 1.3-1.4, the operational state of sensing devices may change over time. For example, in a first operational state, the sensing devices may be able to monitor corresponding scenes. However, in a second operation state, the sensing devices may be unable to monitor all, or a portion, of the corresponding scenes. The operational states of sensing device may change due to, for example, damage to the sensing devices, portions of the corresponding scenes being obscured from the sensors of the sensing devices, malicious action (e.g., hacking, physical attack) by third parties, etc.

As discussed above, a sensing device monitor may monitor one or more sensing devices to ascertain their operational states. Depending on the operation states of the respective sensing devices, the sensing device monitor may perform one or more actions. To further clarify aspects of embodiments of the invention, a diagram of an example sensing device monitor (150) in accordance with one or more embodiments of the invention is shown in FIG. 1.5. The sensing device monitor (100, FIG. 1.1) of FIG. 1.1 may be similar to the example sensing device monitor (150).

As discussed above, sensing device monitors may provide sensing device monitoring services. To provide sensing device monitoring services, the example sensing device monitor (150) may include and/or be operatively coupled to a sensing device manager (152) and/or persistent storage (156). Each of these components of the example sensing device monitor (150) is discussed below.

The sensing device manager (152) may be adapted to orchestrate operation of the example sensing device monitor (150). For example, the sensing device manager (152) may include functionality to obtain scene signatures from sensing devices, store/retrieve data (e.g., scene signatures stored in a scene signature repository) in the persistent storage (156), generate challenges, facilitate performance of the challenges by sensing devices, and/or provide sensing device monitoring services as discussed above. To provide the above noted functionality of the sensing device manager (152), the sensing device manager (152) may perform all, or a portion, of the methods illustrated in FIGS. 3.1-3.3. The sensing device manager (152) may include additional, different, and/or less functionality than that described above.

In one or more embodiments of the invention, the sensing device manager (152) is implemented using a hardware device that includes circuitry. The circuitry of the hardware device may be adapted to perform all, or a portion, of the functionality of the sensing device manager (152) and/or all, or a portion, the methods illustrated in FIGS. 3.1-3.3. The hardware device may be, for example, a digital signal processor, a field programmable gate array, or an application specific integrated circuit. The hardware device may be other types of hardware devices without departing from the invention.

In one or more embodiments of the invention, the sensing device manager (152) is implemented using computing code stored on a persistent storage that when executed by a processor performs all, or a portion, of the functionality of the sensing device manager (152) and/or all, or a portion, of the methods illustrated in FIGS. 3.1-3.3. The processor may be a hardware processor including circuitry such as, for example, a central processing unit or a microcontroller. The processor may be other types of hardware devices for processing digital information without departing from the invention.

In one or more embodiments of the invention, the persistent storage (156) provides data storage services to the sensing device manager (152) and/or other entities. The data storage services may include storing of data and providing of previous stored data. The persistent storage (156) may be implemented using any combination of physical storage device(s), logical storage device(s), and/or other types of devices (e.g., storage device controllers, load balances, encoders, etc.) for facilitating provisioning of data storage services.

A logical storage device may be an entity that utilizes the physical storage devices of one or more computing devices to provide data storage services. For example, a logical storage may be a virtualized storage that utilizes any quantity of storage resources (e.g., physical storage devices) of any number of computing devices.

A physical storage device may be a physical device that provides data storage services. For example, a physical storage device may include any number of physical devices such as, for example, hard disk drives, solid state drives, tape drives, and/or other types of hardware devices that store data. The physical storage device may include any number of other types of hardware devices for providing data storage services. For example, the physical storage device may include storage controllers that balance and/or allocate storage resources of hardware devices, load balancers that distribute storage workloads across any number of hardware devices, memory for providing cache services for the hardware devices, etc.

The persistent storage (156) may store data structures including a scene signature repository (158), a challenge response repository (160), and/or a diagnosis repository (162). Each of these data structures is discussed below.

The scene signature repository (158) may be a data structure that includes any quantity and types of scene signatures obtained from one or more sensing devices. As discussed above, a scene signature may include information associated with a scene. For additional details regarding scene signatures, refer to FIG. 2.

The scene signature repository (158) may also include information (e.g., metadata) regarding the scene signatures included in the scene signature repository (158). The metadata may include, for example, information that associates the scene signatures with sensing devices, one or more points in time and/or one or more periods of time, etc. The metadata of the scene signature repository (158) may include additional, less, and/or different types of information without departing from the invention.

The scene signature repository (158) may be implemented as, for example, a list. Each entry of the list may include information representative of, for example, (i) periods of time and/or points in time associated with when a scene signature associated with the entry was obtained, (ii) an identity of a sensing device associated with the scene signature associated with the entry, and/or (iii) the scene signature associated with the entry. The scene signature repository (158) may have different organizational structures without departing from the invention. For example, the scene signature repository (158) may be implemented as a tree, a table, a linked list, etc.

The challenge response repository (160) may be a data structure that includes any quantity and types of challenge responses obtained from one or more sensing devices. A challenge response may be a data structure that includes information generated by a sensing device in response to a challenge. The information of a challenge response may be any type and/or quantity of information. Different challenge responses may include different types and/or quantities of information.

The challenge response repository (160) may also include information (e.g., metadata) regarding the challenge responses included in the scene signature repository (158). The metadata may include, for example, information that associates the challenge responses with respective sensing devices, one or more points in time and/or one or more periods of time, etc. The metadata of the challenge response repository (160) may include additional, less, and/or different types of information without departing from the invention.

The challenge response repository (160) may be implemented as, for example, a list. Each entry of the list may include information representative of, for example, (i) periods of time and/or points in time associated with when a challenge response associated with the entry was obtained, (ii) an identity of a sensing device associated with the challenge response associated with the entry, and/or (iii) the challenge response associated with the entry. The scene signature repository (158) may have different organizational structures without departing from the invention. For example, the scene signature repository (158) may be implemented as a tree, a table, a linked list, etc.

The diagnosis repository (162) may be a data structure that includes any quantity and types of information that may be utilized to determine one or more actions to be performed based on an operation state of a sensing device. For example, the diagnosis repository (162) may include information that (i) associates challenge responses with respective operational states (e.g., different types of challenge responses may be associated with different operational states) of sensing devices and (ii) associates operational states with one or more actions to be performed. The one or more actions may enable sensing devices to be remediated. Remediating a sensing device may facilitate changing of an operational state (e.g., an operational state in which useful information regarding a scene may not be able to be obtained using the sensing device) of the sensing device to a predetermined operational state (e.g., an operational state in which useful information regarding a scene may be able to be obtained using the sensing device).

The diagnosis repository (162) may be implemented as, for example, a list. Each entry of the list may include information representative of, for example, (i) an association between a challenge response and a corresponding operational state and/or (ii) an association between an operational state and one or more actions (e.g., all, or a portion, of an action set). The diagnosis repository (162) may have different organizational structures without departing from the invention. For example, the diagnosis repository (162) may be implemented as a tree, a table, a linked list, etc.

While the data structures (e.g., 158, 160, 162) are illustrated as separate data structures and have been discussed as including a limited amount of specific information, any of the aforementioned data structures may be divided into any number of data structures, combined with any number of other data structures, and/or may include additional, less, and/or different information without departing from the invention. Additionally, while illustrated as being stored in the persistent storage (156), any of the aforementioned data structures may be stored in different locations (e.g., in persistent storage of other computing devices) and/or spanned across any number of computing devices without departing from the invention.

While the example sensing device monitor (150) of FIG. 1.5 has been described and illustrated as including a limited number of components for the sake of brevity, a sensing device monitor in accordance with embodiments of the invention may include additional, fewer, and/or different components than those illustrated in FIG. 1.5 without departing from the invention.

To further clarify aspects of embodiments of the invention, a diagram of a data structure that may be used by the system of FIG. 1.1 is illustrated in FIG. 2. FIG. 2 shows a diagram of an example scene signature (200) in accordance with one or more embodiments of the invention. As discussed above, scene signatures may be utilized by the system of FIG. 1.1 to determine an operational state of a sensing device. A scene signature may be generated when a sensing device is in a predetermined operational state (e.g., an operational state in which useful information regarding a scene may be able to be obtained using the sensing device). Information included in challenge responses may be compared to information included in a scene signature (e.g., 200) to determine an operational state of a sensing device.

In one or more embodiments of the invention, the example scene signature (200) includes static object characteristics (202) and dynamic objects characteristics (204). Each components of the example scene signature (200) is discussed below.

The static objects characteristics (202) may include information representative of static objects (e.g., non-transitory) in a scene. The static objects characteristics (202) may include any type and/or quantity of information regarding the static objects in a scene. The information regarding the static objects may include, for example, the number of each type of static object in a scene, colorings of the static objects in the scene, relative positioning and/or orientation of static objects with respect to other static objects in the scene, etc.

The dynamic objects characteristics (204) may include information representative of dynamic objects (e.g., transitory) in a scene. The dynamic objects characteristics (204) may include any type and/or quantity of information regarding the dynamic objects in a scene. The information regarding the dynamic objects may include, for example, the number of each type of dynamic object in a scene, colorings of the dynamic objects in the scene, relative positioning and/or orientation of dynamic objects with respect to other static objects in the scene, statistical information (e.g., average, mean, standard of deviation, etc.) regarding any of the aforementioned types of information, etc.

The static objects characteristics (202) and the dynamic objects characteristics (204) may be based on sensor data. For example, sensing devices may object sensor data using sensors. The sensor data may be used to derive the static objects characteristics (202) and the dynamic objects characteristics (204). The static objects characteristics (202) and the dynamic objects characteristics (204) may be obtained based on the sensor data using any method without departing from the invention. For example, the static objects characteristics (202) and the dynamic objects characteristics (204) may be obtained using machine learning algorithms, artificial intelligence algorithms, pattern matching algorithms, etc.

In one or more embodiments of the invention, the static objects characteristics (202) and the dynamic objects characteristics (204) are generated by sensing devices. For example, the sensing devices may include functionality to identify the aforementioned characteristics based on sensor data. The sensor data may be multidimensional (e.g., may be data obtained from multiple sensors). The multidimensional sensor data may include similar types of sensed data (e.g., only images, only audio recordings, etc.) or different types of sensed data (e.g., images, audio recordings, and infrared images)

In one or more embodiments of the invention, a portion of the static objects characteristics (202) and/or the dynamic objects characteristics (204) are associated with a second sensing device. For example, a scene associated with a first sensing device may, at least transitorily (e.g., the first sensing device may be moving, rotating, etc.), include the second sensing device. Thus, an example scene signature (200) in accordance with one or more embodiments of the invention may include information regarding the operational state of a sensing device that did not generate the example scene signature (200).

Returning to FIG. 1.1, the sensing device monitor (100) may monitor the sensing devices (102). FIG. 3.1 illustrates a method that may be performed by the sensing device monitor (100) of the system of FIG. 1.1 when monitoring the sensing devices (102).

FIG. 3.1 shows a flowchart of a method in accordance with one or more embodiments of the invention. The method depicted in FIG. 3.1 may be used to monitor sensing devices in accordance with one or more embodiments of the invention. The method shown in FIG. 3.1 may be performed by, for example, a sensing device monitor (e.g., 100, FIG. 1.1). Other components of the system illustrated in FIG. 1.1 may perform all, or a portion, of the method of FIG. 3.1 without departing from the invention.

While FIG. 3.1 is illustrated as a series of steps, any of the steps may be omitted, performed in a different order, additional steps may be included, and/or any or all of the steps may be performed in a parallel and/or partially overlapping manner without departing from the invention.

In step 300, a scene signature from the sensing device is obtained.

In one or more embodiments of the invention, the scene signature is obtained by sending a request to the sensing device. The request may specify that the sensing device is to generate the scene signature and/or provide the scene signature to a sensing device monitor. The scene signature may be obtained from the sensing device by having the sensing device provide the scene signature to the sensing device monitor. The scene signature may be obtained from other devices without departing from the invention. For example, another device (separate from the sensing device) may store a copy of the scene signature and the scene signature may be obtained using the copy of the scene signature.

In one or more embodiments of the invention, the request for the scene signature includes one or more parameters that specify how the scene signature is to be generated. For example, the request for the scene signature may specify the period of time during which the scene signature is to be generated. In another example, the request for the scene signature may specify the type of the scene signature that is to be generated. The type of the scene signature may be associated with parameters that specify how the scene signature is to be generated.

In one or more embodiments of the invention, obtaining the scene signature includes obtaining metadata regarding the scene signature. For example, the metadata may specify periods of time and/or points in time associated with different portions of the scene signature.

For example, a scene signature may include a first portion associated with a point in time. The association may be that the sensor data used to generate the first portion was obtained at the point in time.

In another example, a scene signature may include a second portion associated with the period of time. The association may be that the sensor data used to generate the second portion was obtained during the period of time.

In step 302, a challenge is generated based, at least in part, on the scene signature.

In one or more embodiments of the invention, the challenge is a data structure that includes parameters that specify how a challenge response is to be generated. The parameters may specify, for example, characteristics of static and/or dynamic objects in the scene that are to be included in the challenge response. The parameters may also specify, for example, a point in time and/or a period of time during which sensor data, upon which the characteristics of the static and/or dynamic objects are to be based, is to be obtained.

For example, a challenge may specify a first parameter that indicates a point in time during which sensor data is to be obtained. The challenge may further specify a second parameter that indicates that characteristics of a static object of the scene are to be included in the challenge response. In response to obtaining this challenge, a sensing device may obtain sensor data at the point in time and generate characteristics of the static object based on the obtained sensor data.

Any number of challenges may be generated in step 302. The challenges may be associated with the same and/or different sensing devices. The challenges may be based on scene signatures associated with the corresponding sensing device.

In one or more embodiments of the invention, the challenge specifies one or more characteristics of one or more dynamic objects and/or characteristics of one or more static objects of the scene signature. For example, the challenge may specify a subset of all the characteristics of the dynamic objects and/or static objects specified by the scene signature.

In one or more embodiments of the invention, the challenge includes multiple sub-challenges. A sub-challenge may be a challenge that is based on a second scene signature associated with the scene signature. The association may be, for example, that the second scene signature includes information representative of an operational state of the sensing device. For example, the second scene signature may be based on a scene associated with a second sensing device that includes the sensing device. In other words, a second sensing device may be able to obtain sensor data associated with the sensing device. In such a scenario, a sub-challenge may be a request for characteristics of static and/or dynamic objects in the second scene that may impact the operational state of the sensing device. A challenge may include any number of sub-challenges without departing from the invention.

In step 304, the challenge is issued to, at least, the sensing device to obtain a challenge response.

In one or more embodiments of the invention, the challenge is issued by sending a copy of the challenge to the sensing device. The challenge may also be issued to other sensing devices by sending a sub-challenge of the challenge to the other sensing devices.

For example, in a scenario in in which a first sensing device monitors a scene that includes a second sensing device, a sub-challenge of the challenge may be issued to the second sensing device. By doing so, multiple challenge responses that may include information that is relevant to the operational state of the second sensing device may be obtained.

In step 306, it is determined whether the challenge response passes the challenge.

In one or more embodiments of the invention, the challenge response passes the challenge if the characteristics of the static objects and/or the dynamic objects included in the challenge response match the characteristics of the static objects and/or the dynamic objects in the scene signature upon which the challenge is based.

In one or more embodiments of the invention, matching means to be within a predetermined range with respect to a target value. The predetermined range may be, for example, plus and/or minus 5%, 10%, 20%, etc. of the target value.

For example, if a challenge response specifies that the number of a static object is 15 and the number of the static object in the scene signature associated with the challenge response is 16, the challenge response may match the scene signature even though the match is not an exact match but matched the range of 16+/−1.6 (i.e., 10% of the target value).

The predetermined range may be specified using other methods without departing from the invention.

In one or more embodiments of the invention, the challenge response passes the challenge if the majority of the characteristics of the static objects and/or the dynamic objects included in the challenge response match the characteristics of the static objects and/or the dynamic objects in the scene signature upon which the challenge is based. For example, a challenge response may include 10 characteristics of static and/or dynamic objects. If at least 6 of the characteristics match corresponding characteristics specified by an associated scene signature, the challenge response may pass the challenge.

The challenge response passes the challenge using other comparisons between the challenge response and an associated scene signature without departing from the invention.

If the challenge response passes the challenge, the method may proceed to step 310. If the challenge response does not pass the challenge, the method may proceed to step 308.

In step 308, the sensing device is remediated.

In one or more embodiments of the invention, the sensing device is remediated by identifying an operating state of the sensing device. The operating state of the sensing device may be used to identify one or more actions (e.g., an action set) to be performed to remediate the sensing device. The operating state of the sensing device and/or the one or more actions to be identified based on the diagnosis repository (162, FIG. 1.5).

In one or more embodiments of the invention, the sensing device is remediated by performing the one or more actions. The one or more actions may be any type of action that may be performed by the sensing device monitor.

In one or more embodiments of the invention, the one or more actions include an action that causes a person to be notified of the operating state of the sensing device. For example, an electronic communication may be sent to a computing device associated with the person. The electronic communication may indicate/include information regarding the sensing device and/or of the operating state of the sensing device.

In one or more embodiments of the invention, the one or more actions include an action that causes step 304 to be performed again. By doing so, the sensing device may be repeatedly challenged to verify the operating state of the sensing device.

In one or more embodiments of the invention, the one or more actions include an action that causes a person that utilizes the monitoring services associated with the sensing device to be notified of the operating state of the sensing device. For example, an electronic communication may be sent to a computing device associated with the person. The electronic communication may indicate/include information regarding the sensing device and/or of the operating state of the sensing device. The notification to the person may also include other information such as, for example, an estimated time to repair the sensing device, other sensing devices that may be used to provide similar monitoring services for the scene, and/or other types of information that may be utilized by the person that utilizes the monitoring services to not be impacted by the operating state of the sensing device.

Returning to step 306, if the challenge response passes the challenge, the method may proceed to step 310.

In step 310, a scene signature repository and/or a diagnosis repository is updated based on the challenge, the challenge response, and/or remediation of the sensing device.

In one or more embodiments of the invention, the scene signature repository is updated by modifying an existing scene signature associated with the sensing device and/or adding a new scene signature associated with the sensing device. The modification to the existing scene signature and/or the new scene signature may be based on characteristics of static and/or dynamic objects specified in the challenge response.

The scene signature repository may be updated when, for example, it is determined when performing the remediation of the sensing device that the operating state of the sensing device associated with the challenge response enables the sensing device to obtain accurate information regarding the scene. In other words, when remediated in the sensing device, it may be determined that the scene has changed (e.g., characteristics of the dynamic/static objects of the scene changed) and updating and/or adding a scene signature may be warranted for the purposes of accurately determining the operating state of the sensing device.

In one or more embodiments of the invention, the diagnosis repository is updated by adding information obtained when performing the remediation of the sensing device. For example, when remediating the sensing device, a person may interact with the sensing device to diagnose a problem that caused the change in the operating state of the sensing device. Such associations may be added to the diagnosis repository and/or used to modify existing associations of the diagnosis repository.

The method may end following step 310.

Returning to FIG. 1.1, the sensing devices (102) may monitor scenes associated with the respective devices. When monitoring scenes, the sensing devices (102) may first go through a processes of generating scene signatures (e.g., a training phase) before monitoring the scene (e.g., a monitoring phase) using the generated scene signatures. FIG. 3.2 illustrates a portion of a method that may be performed by the sensing device monitor (100) of the system of FIG. 1.1 when monitoring the sensing devices (102) when performing a training phase. FIG. 3.2 illustrates a second portion of the method that may be performed by the sensing device monitor (100) of the system of FIG. 1.1 when monitoring the sensing devices (102) when performing scene monitoring using scene signatures obtained during a training phase. These portions of the method may be performed at different points in time, may be performed repeatedly (e.g., performing training, then monitoring, then training, then monitoring, etc.), or may otherwise be utilized to provide scene monitoring functionality.

FIG. 3.2 shows a flowchart of a method in accordance with one or more embodiments of the invention. The method depicted in FIG. 3.2 may be used to monitor scenes by generating scene signatures (e.g., a training phase) in accordance with one or more embodiments of the invention. The method shown in FIG. 3.2 may be performed by, for example, sensing devices (e.g., 102, FIG. 1.1). Other components of the system illustrated in FIG. 1.1 may perform all, or a portion, of the method of FIG. 3.2 without departing from the invention.

While FIG. 3.2 is illustrated as a series of steps, any of the steps may be omitted, performed in a different order, additional steps may be included, and/or any or all of the steps may be performed in a parallel and/or partially overlapping manner without departing from the invention.

In step 320, sensor data associated with the scene at a first point in time is obtained. As discussed above, the sensor data may be obtained from any number of sensors. The sensors may be a part of the sensing device or may be operably coupled to the sensing device. Any quantity and/or type of sensor data may be obtained in step 320.

In one or more embodiments of the invention, the sensor data is obtained in response to a request for a scene signature. The request may be obtained from a sensing device monitor and/or another entity.

In step 322, a scene signature is generated based on the sensor data.

In one or more embodiments of the invention, the scene signature is generated by identifying characteristics of static and/or dynamic objects disposed in the scene. The characteristics of the static and/or dynamic objects disposed in the scene may be identified based on the sensor data.

In one or more embodiments of the invention, the signature is generated by performing on the learning algorithm based on the sensor data. The learning algorithm may be, for example, a machine learning algorithm, a pattern matching algorithm, or another type of learning algorithm.

The learning algorithm may have been previously trained based on any quantity of sensor data (e.g., training data) associated with characteristics of static and/or dynamic objects. For example, the training data may have been previously characterized to identify characteristics of static and/or dynamic objects included in the training data. The training data may have been previously characterized by a person.

Once generated, the scene signature may be provided to another entity. For example, the scene signature may be provided to a sensing device monitor that provides sensing device monitoring services for the sensing device. The scene signature may be provided to other entities without departing from the invention.

The sensor data of step 320 and/or if the scene signature of step 322 may be removed from the sensing device after the sensing device provides the scene signature to another entity. For example, the sensor data and/or the scene signature may be deleted in an unrecoverable manner.

The method may proceed to a continuation of the flow chart via the boxes labeled as ‘A’ in each of the diagrams following Step 322.

After performing steps 320-322, scene signatures that may be used for future monitoring may have been generated. As discussed above, the scene signatures may include any type and quantity of information regarding static and dynamic objects of a scene. Such information may be utilized during future monitoring of scenes to determine operating states of device(s) tasked with monitoring the scene.

FIG. 3.3 shows a flowchart of a method in accordance with one or more embodiments of the invention. Specifically, a continuation of the method illustrated in FIG. 3.2. The method depicted in FIG. 3.3 may be used to monitor scenes using scene signatures (e.g., a monitoring phase) in accordance with one or more embodiments of the invention. The method shown in FIG. 3.3 may be performed by, for example, sensing devices (e.g., 102, FIG. 1.1). Other components of the system illustrated in FIG. 1.1 may perform all, or a portion, of the method of FIG. 3.3 without departing from the invention.

While FIG. 3.3 is illustrated as a series of steps, any of the steps may be omitted, performed in a different order, additional steps may be included, and/or any or all of the steps may be performed in a parallel and/or partially overlapping manner without departing from the invention.

In step 324, a challenge that is based, at least in part, on a portion of the scene signature is obtained. In other words, a challenge that was generated using a scene signature is generated.

In one or more embodiments of the invention, the challenge is obtained from the sensing device monitor.

In one or more embodiments of the invention, the sensing device does not include any records of the scene signature at the time the challenge is obtained. For example, after the scene signature is generated in step 322, the scene signature may be provided to another entity (e.g., a sensing device monitor) and all records of the scene signature may be removed from the sensing device. By doing so, all traces of information that may be used to derive a passing challenge response may be removed from the sensing device.

In step 326, second sensor data associated with the scene at a second point in time is obtained in response to the challenge.

In one or more embodiments of the invention, the second sensor data is obtained from one or more sensors. The second sensor data may be obtained from all, or a portion, of the sensors used to obtain the sensor data in step 320. For example, the challenge may only indicate that a portion of the characteristics of the static and/or dynamic objects of the scene are to be included in response to the challenge. In such a scenario, only a portion of the sensors used to obtain the sensor data in step 320 may be used to obtain the second sensor data. The second sensor data may be obtained in a manner similar to that when the sensor data of step 320 was obtained.

In step 328, a challenge response is generated based on the second sensor data.

In one or more embodiments of the invention, the challenge response is generated by identifying characteristics of one or more static and/or dynamic objects in the scene using the second sensor data. For example, the learning algorithm of step 322 may be used to identify the characteristics of the one or more static and/or dynamic objects in the scene using the second sensor data.

In one or more embodiments of the invention, the challenge response includes identified characteristics of the one or more static and/or dynamic objects.

In one or more embodiments of the invention, the challenge response does not include the second sensor data and/or any other sensor data. The challenge response may only include information derived from or based on the second sensor data.

In step 330, the challenge response is provided to an entity associated with the challenge. For example, the challenge may indicate an entity to which challenge response is to be provided. In another example, the entity may be associated with the challenge by providing the challenge.

In one or more embodiments of the invention, the challenge response is provided to the entity by sending a copy of the challenge response to the entity.

The method may end following step 330.

Thus, via the methods illustrated in FIGS. 3.1-3.3, a sensing device may be monitored prior to, during, and/or after the sensing device monitors a scene. By doing so, the accuracy of the monitoring of the scene may be determined. For example, the sensing device may be challenged at a different point in time and, based on responses to the challenge, the operating state of the sensing device may be determined. The operating state of the sensing device may be used to determine whether the results of the monitor of the scene are likely to be accurate.

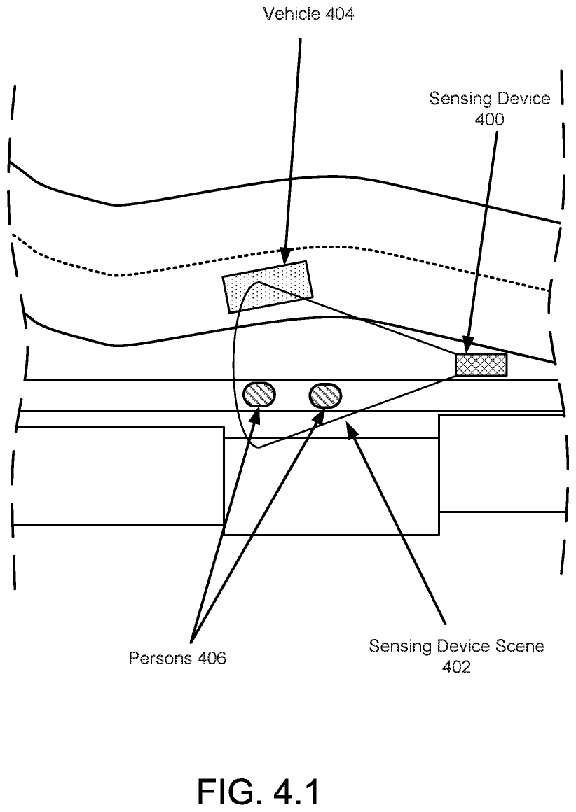

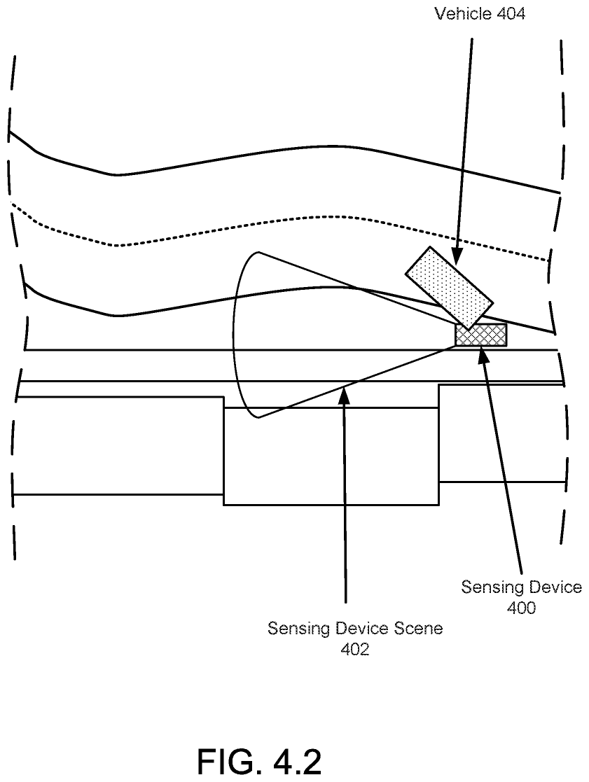

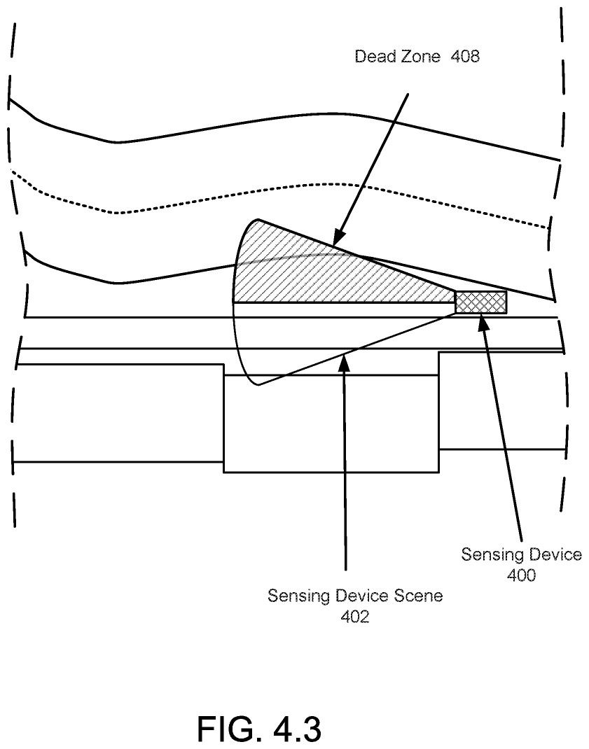

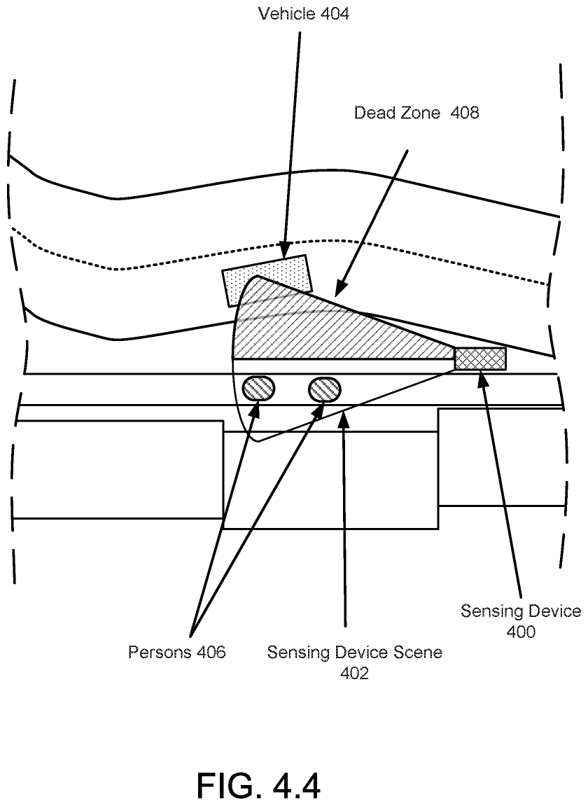

To further clarify embodiments of the invention, a non-limiting example is provided in FIGS. 4.1-4.4. Each of these figures may illustrate a system similar to that of FIG. 1.1 at different points in times. For the sake of brevity, only a limited number of components of the system of FIG. 1.1 are illustrated in each of FIGS. 4.1-4.4.

### Example

Consider a scenario as illustrated in FIG. 4.1 in which a sensing device (400) is providing monitoring services for the sensing device scene (402). The sensing device scene (402) may include a road over which vehicles (e.g., 404) travel and a walkway over which persons (406) travel.

At a first point in time, a sensing device monitor (not shown) may request that the sensing device (400) generate a scene signature for the sensing device scene (402). In response to obtaining the request, the sensing device (400) may obtain sensor data associated with the sensing device scene (402). The sensing device data may include images of the sensing device scene (402) taken over a predetermined period of time.

Using the sensor data, the sensing device (400) may generate a scene signature that specifies that four persons per hour walk through the sensing device scene (402) and that 2.3 vehicles (e.g., 104) per minute passed through the sensing device scene (402). Once generated, the sensing device (400) provides the scene signature to the sensing device monitor. After providing the scene signature to the sensing device monitor, the sensing device (400) deletes the sensor data and the scene signature from persistent storage. By doing so, information that may be relevant for determining passing challenge responses may be removed from the sensing device (400).

At a second point in time as illustrated in FIG. 4.2, a vehicle (404) may crash into the sensing device (400). The crash causes damage to the sensing device (400) that causes the sensing device (400) to be unable to obtain sensor data throughout a portion of the sensing device scene (402) as illustrated in FIG. 4.3. For example, the damaged sensing device (400) may cause a dead zone (408) to be formed in the sensing device scene (402). Consequently, the sensing device (400) may only be able to obtain sensor data corresponding to the region of the sensing device scene (402) outside of the dead zone (408).

At a third point in time as illustrated in FIG. 4.3, the sensing device monitor issues a challenge to the sensing device (400). The challenge to the sensing device (400) requests that the sensing device (400) determine the average number of vehicles (404) that pass through the sensing device scene (402) per minute for the next 10 minutes following the third point in time.

In response to the challenge issued by the sensing device monitor, the sensing device (400) obtains sensor data for the sensing device scene (402) over the 10 minute period of time. However, because of the dead zone (408), the sensor data does not indicate that any vehicles (e.g. 404) pass through the sensing device scene (402) during the 10 minute period even though 2.3 vehicles per minute passed through the sensing device scene (402) during the 10 minute period.

After obtaining the sensor data, the sensing device (400) generates a challenge response that indicates that zero vehicles per minute passed through the sensing device scene (402). Once generated, the sensing device (400) provides the challenge response to the sensing device monitor.

In response to receiving the sensing device monitor, the sensing device monitor compares the challenge response to the scene signature and determines that the operating state of the sensing device (400) renders it unable to provide accurate information regarding the sensing device scene (402). The determination is made because the challenge response indicates that zero vehicles per minute passed through the sensing device scene (402) while the scene signature indicates that 2.3 vehicles per minute pass through the sensing device scene (402). This difference indicates that the sensing device (400) is an operating state that renders it unable to accurately determine information regarding the sensing device scene (402).

In response to the determination, the sensing device monitor takes action to remediate the sensing device (400).

End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Embodiments of the invention may provide methods, devices, and/or systems for monitoring sensing devices. Specifically, embodiments of the invention may facilitate determining the operating states of sensing devices using sensor data obtained by the sensing devices. The determined operating states of the sensing devices may be used to determine the accuracy of information regarding scenes obtained from the sensing devices. By doing so, embodiments of the invention may enable whether information regarding a scene is reliable to be determined. Consequently, downstream users of the information regarding the scene may take steps to improve the accuracy of their estimates of the states of various scenes.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A sensing device monitor for monitoring operation of sensing devices, comprising:
persistent storage for storing a scene signature associated with a sensing device of the sensing devices; and
a sensing device manager programmed to:
generate a challenge based, at least in part, on the scene signature;
issue the challenge to, at least, the sensing device to obtain a challenge response;
make a determination that the challenge response does not pass the challenge; and
in response to the determination:
remediate the sensing device.

2. The sensing device monitor of claim 1, wherein the scene signature comprises:
a characteristic of a static object in a scene associated with the sensing device.

3. The sensing device monitor of claim 2, wherein the characteristic of the static object is a number of the static object in the scene at a point in time.

4. The sensing device monitor of claim 1, wherein the scene signature comprises:
a characteristic of a dynamic object in a scene associated with the sensing device.

5. The sensing device monitor of claim 4, wherein the characteristic of the dynamic object is a time average of a number of the dynamic object identified using sensor data associated with the scene.

6. The sensing device monitor of claim 1, wherein the sensing device monitor is further programmed to:
obtain the scene signature from the sensing device prior to generating the challenge.

7. The sensing device monitor of claim 1, wherein remediating the sensing device comprises:
matching the challenge response to a set of actions to be performed to remediate the sensing device.

8. A method for monitoring operation of sensing devices, comprising:
generating a challenge based, at least in part, on a scene signature associated with a sensing device of the sensing devices;
issuing the challenge to, at least, the sensing device to obtain a challenge response;
making a determination that the challenge response does not pass the challenge; and
in response to the determination:
remediating the sensing device.

9. The method of claim 8, wherein the scene signature comprises:
a characteristic of a static object in a scene associated with the sensing device.

10. The method of claim 9, wherein the characteristic of the static object is a number of the static object in the scene at a point in time.

11. The method of claim 8, wherein the scene signature comprises:
a characteristic of a dynamic object in a scene associated with the sensing device.

12. The method of claim 11, wherein the characteristic of the dynamic object is a time average of a number of the dynamic object identified using sensor data associated with the scene.

13. The method of claim 8, further comprising:
obtaining the scene signature from the sensing device prior to generating the challenge.

14. The method of claim 8, wherein remediating the sensing device comprises:
matching the challenge response to a set of actions to be performed to remediate the sensing device.

15. A non-transitory computer readable medium comprising computer readable program code, which when executed by a computer processor enables the computer processor to perform a method for monitoring operation of sensing devices, the method comprising:
generating a challenge based, at least in part, on a scene signature associated with a sensing device of the sensing devices;
issuing the challenge to, at least, the sensing device to obtain a challenge response;
making a determination that the challenge response does not pass the challenge; and
in response to the determination:
remediating the sensing device.

16. The non-transitory computer readable medium of claim 15, wherein the scene signature comprises:
a characteristic of a static object in a scene associated with the sensing device.

17. The non-transitory computer readable medium of claim 16, wherein the characteristic of the static object is a number of the static object in the scene at a point in time.

18. The non-transitory computer readable medium of claim 15, wherein the scene signature comprises:
a characteristic of a dynamic object in a scene associated with the sensing device.

19. The non-transitory computer readable medium of claim 18, wherein the characteristic of the dynamic object is a time average of a number of the dynamic object identified using sensor data associated with the scene.

20. The non-transitory computer readable medium of claim 15, wherein the method further comprises:
obtaining the scene signature from the sensing device prior to generating the challenge.
